(19) United States
(12) Patent Application Publication
(10) Pub. No.: US 2003/0027566 A1
(43) Pub. Date: Feb. 6, 2003

(54) Session management method & system

(75) Inventor: Moshe Weiner, Kiron (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: COMVERSE NETWORK SYSTEMS, LTD.

(21) Appl. No.: 09/916,325

(22) Filed: Jul. 30, 2001

(51) Int. Cl. H04Q 7/20

(52) U.S. Cl. 455/426; 455/557; 455/556

(57) ABSTRACT

The present invention is a session management method and system. The method includes initiating a first session in a first device connected to a data source; initiating a second session in the first device while the first data session is still running; stopping the first session in the first device; and continuing the first session in a session management server. The system includes a first device that is able to receive data from a data source; a control device connected to the first device; and a session management server connected to the first device and the data source that controls the flow of data from the data source to the first device; wherein the control device is used to control the session management server.

### BACKGROUND OF THE INVENTION

This present invention relates generally to data flow and control for terminals such as handsets. More specifically, it is related to a method and a system for providing a cellular handset user with interactive control over the handset's activities. This enables a cellular handset to multitask data sessions in an environment that enables only one data session, enables easy transfer from a packet switched data session to a circuit switched voice session, even in the middle of a data session, and enables interactive commands to affect a data stream, such as zooming in on a portion of a picture that has started, but not completed, downloading to the handset. Interactive commands also include fast forward, pause, rewind, etc.

Users, such as cellular phone users, are now demanding more out of their services. Users require the ability to send and receive text and data items such as business cards, post cards and pictures. Also, in the 3G cellular (3rd generation of cellular communication specifications) architecture, a new component has been added. This component is called Multimedia Messaging Service (MMS). Multimedia messaging service is the ability to send and receive messages comprising a combination of text, sounds, images and video to MMS capable handsets and computers. MMS is a component that can be connected to all possible networks, such as cellular networks, broad band networks, fixed line and Internet networks. As technology is evolving, so are the needs of its users.

MMS was developed to enhance messaging based on the users' new demands. As stated above, this allows users of cellular phones to send and receive messages exploiting the whole array of media types, while also making it possible to support new content types as they become popular. MMS is well known in the telecommunications world and is standardized (see Standards 23.140 and 23.140 of the 3 GPP-3G Partnership Project at www.3gpp.org, incorporated herein by reference for a further explanation of MMS).

With these new abilities, however, come problems. One such problem is the ability to enable multiple sessions running simultaneously. In conventional devices, the handset is typically expected to be dedicated to one session. For example, users are unable to receive or make a voice call on the handset while the handset is in the middle of downloading data. If the user takes or makes a voice call, data transmission is typically stopped and has to be started again from the beginning, once the voice call is completed. This problem also exists if the user wants to enable two data sessions, for example downloading a picture and an MP3 file. There is no control feature within the picture downloading protocol that enables switching to an MP3 session.

Recently, there have been discussions about enabling incoming circuit switched calls while a wireless application protocol (WAP) session is taking place. Also, an improved version of FTP (File Transfer Protocol) has the ability to suspend file downloading and resume the downloading later on from the point at which it was interrupted. However, these existing solutions do not enable multiple sessions running simultaneously, nor do the solutions include control commands integrated within the information flow. The existing solutions that use servers, use the servers for only translation of protocols, but not for sharing the load with the handset. Furthermore, there is no existing information flow protocol that includes other control functions that are not directly related to the information flow.

### SUMMARY OF THE INVENTION

The present invention solves the above-described problems and limitations by providing a server that is located in the telephone network. The server performs the functions that a normal end device would be performing if all sessions were open. For example, the server, which acts like a buffer, is located between the handset and the network. This buffering server makes connections with other servers that provide Internet browsing, etc. The handset receives information from the buffering server and can also provide the buffering server with commands. These commands include informing the buffering server not to send the handset further information from the first session, but rather information from a second Internet session.

With this capability, the buffering server can open two Internet sessions with various Internet sites and provide the handset with the information from either of the sessions. This architecture places a significantly smaller load on a handset because the handset does not have to deal with the network content provider devices. As a result, memory and control commands do not have to be included in the handset. The handset receives only the information stream from the session management server. Furthermore, if more then one session is open with the content providers (such as Internet sites, etc.), the handset is not involved in keeping these sessions open.

Computer users are familiar with a problem PCs used to have when downloading a large file to a PC which is connected to a network by a modem device. Downloading took a long time and until the downloading was complete, the user could not use the PC to perform other functions. Today, because of the limited memory of a typical mobile handset and the growing amount of data that can be downloaded (such as pictures, videos. MP3 files, etc.) it is likely that the handset will not be usable while non real time data is downloaded. As a result, the user might have very limited time periods during which the user can control the handset, and having started one data session, it will not be possible to put the data session on hold and go to another data session.

This invention alleviates this problem by providing a new method and system for controlling a handset while one or more data sessions take place (such as downloading). This enables a handset to be more responsive and usable during long periods of downloading data.

An embodiment of the method of the present invention includes initiating a first session in a first device connected to a data source; initiating a second session in the first device while the first data session is still running; stopping the first session in the first device; and continuing the first session in a session management server.

Another embodiment of the method of the present invention includes initiating a session in a first device to download data from a data source; and manipulating the data while the session is still running and prior to all of the data being downloaded to the first device.

An embodiment of the present invention includes a first device that is able to receive data from a data source; and a session management server connected to the first device and the data source that controls the flow of data from the data source to the first device; wherein the first device is used to control the session management server.

One object of the invention is to enable load sharing between a limited handset and a powerful server.

Another object of the invention is to enable the ability to interrupt a data session and to continue it at a later time from the point at which it was interrupted.

Another object of the invention is to enable multiple data sessions on a single handset device.

Another object of the invention is to enable a smooth transition from a data session (such as WAP data session) to a circuit switched voice call and vice a versa.

Another object of the invention is to provide a new protocol for data flow (file based or stream) that includes control commands that are not related to the data flow, but to a handset (such as GO TO VOICE SESSION or ADD SESSION) or data manipulation such as ZOOMING a picture that was not completely downloaded or FAST FORWARDING to an MP3 string that was not completely downloaded or sending only voice and omitting the video of a message, etc.

Further objects, features and advantages of the invention will become apparent from a consideration of the following description and the appended claims when taken in connection with the accompanying drawings.

### BRIEF DESCRIPTION OF THE DRAWINGS

The above aspects of the present invention will become more apparent by describing in detail embodiments thereof with reference to the attached drawings, in which:

FIG. 1 is a block diagram illustrating the interrelationships between the components of the system of the present invention;

FIG. 2 is a flow chart of the method of the present invention;

FIG. 3 is a flow chart of an example of the method of the present invention; and

FIG. 4 is a block diagram illustrating one example of a cellular telephone with dedicated control hot keys.

FIG. 5 is a block diagram illustrating one embodiment of a session management server.

FIG. 6 is a flow chart illustrating the basic operation of one embodiment of a session management server.

### DETAILED DESCRIPTION OF THE PREFERRED EMBODIMENTS

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to one skilled in the art.

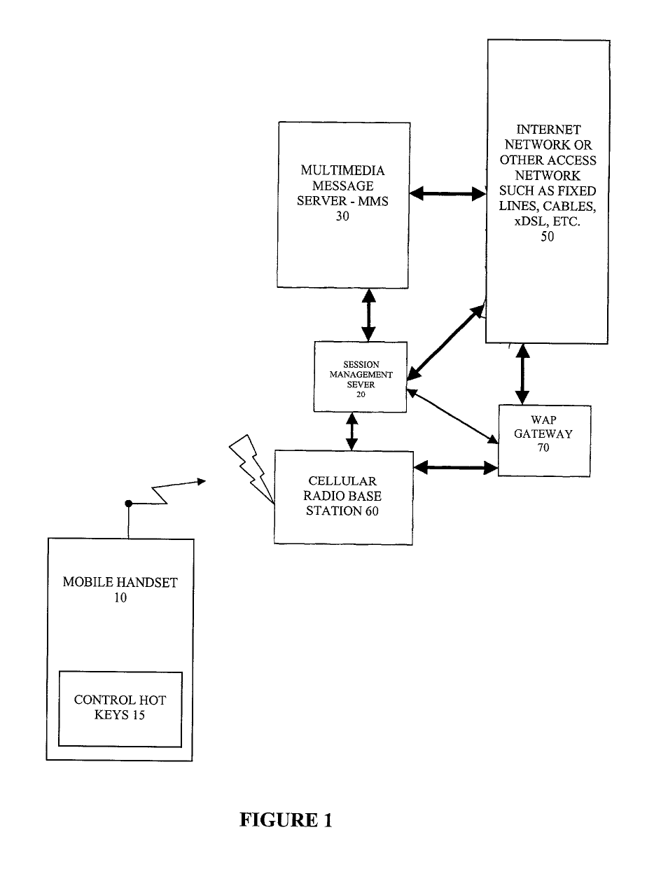

FIG. 1 illustrates building blocks of one embodiment of the invention. A mobile handset 10 can be used for multiple data sessions. Examples of mobile handset 10 include personal data assistants (PDAs), cellular telephones, personal computers (PCs) and other devices that can be connected to a data source. A preferred embodiment is a cellular telephone. If mobile handset 10 is a cellular telephone, it can be used for both data and voice sessions. Note that mobile handset 10 does not have to be “mobile” or a “handset.” For example, it could be a remote PC that is connected to a data source via a modem.

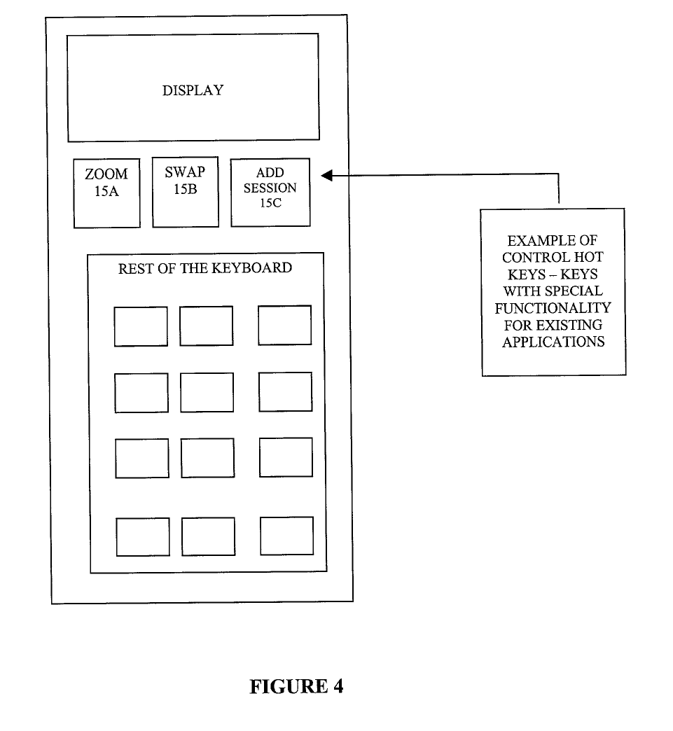

Mobile handset 10 includes control hot keys 15. Control hot keys 15 can be separate dedicated keys on the handset or existing keys that also perform a control function. For example, if mobile handset 10 is a cellular telephone, control hot keys 15 could be activated by pressing the * or # key and one of the number keys. In addition, control hot keys 15 can be on a separate device that is connected by cable or wirelessly to the handset. FIG. 4 is a block diagram showing an illustrative example of a mobile handset with separate dedicated control hot keys 15A, 15B and 15C for ZOOM, SWAP and ADD SESSION functions.

Unlike a conventional data session, in which mobile handset 10 is expected to be dedicated for just one data session, in this invention, the user can use control hot keys 15 to manage multiple sessions. For example, the user initiates a first data session between mobile handset 10 and a data source, via a cellular base station 60, that will take some time to complete, such as downloading a large text or picture file.

While that first data session is still in progress, control hot keys 15 can be used to place the first data session on hold and initiate a second data session or a voice session. Later on, control hot keys 15 can be used to continue the first data session at the point at which it left off.

Examples of some of the functions performed by control hot keys 15 are shown in Table A below:

TABLE A

| FUNCTION | DESCRIPTION |
|---|---|
| STOP SESSION | Stops the session on the handset, but continues it |
| | in the session management server. In order to |
| | keep the session open, control communication |
| | continues. For example, an Internet site inquiring |
| | “are you still there” - and the session management |
| | server responding - “yes I am.” There is no need |
| | to receive information from a server in order to |
| | keep the session open. Buffering is also possible |
| | if the user (handset) initiates downloading and |
| | would like to receive the downloaded information |
| | from the session management server at a later |
| | time. |
| RESUME SESSION | Resumes a session that had been previously |
| | stopped. |
| FAST FORWARD | Forwards to a later portion of a data file (audio, |
| | video, voice mail message, etc.) |
| NEXT MESSAGE, | If the downloaded data contains technical pauses |
| NEXT SONG, | (such as breaks between songs, video tract, |
| NEXT VIDEO | voicemail messages, etc.), these commands allow |
| TRACK | the user to fast forward to specific points in the |
| | data. |
| GO TO VOICE | Stops a session (in the handset but continues it in |
| SESSION | the server) and allows a voice call to be made. |
| | See also the description of STOP SESSION |
| | above. |
| SEND ONLY VOICE | Sends only voice and not data. |
| ZOOM | Enlarges/shrinks a picture that was not completely |
| | downloaded. |
| ADD SESSION | Starts a new data session. Note that the old data |
| | session can remain open in the session |
| | management server and any data buffering could |
| | continue. |
| SWAP | Swaps between one active data session to |
| | another. If more than one data session is “on |
| | hold,” the user is provided with a means for |
| | identifying the different session. For example, a |
| | URL could be provided. |
| BOOK MARK | Makes a book mark in a data session that will |
| | enable the user to come back at a later point in |
| | time to the same point of the session. When the |
| | user returns, the data session in the session |
| | management server can be continued from the |
| | book marked point of the session. Note that a |
| | book mark can be placed at any point of the data |
| | session. |

Note that if mobile handset 10 is a PDA connected via a Bluetooth or similar connection, cellular base station 60 could be replaced with a Bluetooth or similar base station. If mobile handset 10 is a remote PC operated on a remote site and connected via a low bit-rate connection, cellular base station 60 could be replaced with a wired modem. Alternatively a PC could have a cellular card such as a GSM, GPRS, edge or 3G card, and in these cases the base station could be a cellular base station. Furthermore, a PC could also be connected via a Bluetooth or similar connection to a Bluetooth or similar base station.

Managing multiple sessions is enabled by using a session management server 20. Session management server 20 is connected to a data source, such as Internet site, FTP site, etc., and mobile handset 10. In a preferred embodiment, mobile handset 10 is connected to session management server 20 via cellular radio base station 60. Session management server 20 performs a spoofing function for mobile handset 10. Session management server 20 does this by acting as the end point (mobile handset 10) to the source of the data session.

Session management server 20 opens a session with the remote site as well as with the handset (or PDA, PC etc). The data flows from the remote site to the handset in a transparent way—thus, session management server 20 does not influence the data flow from the user's point of view. However, session management server 20 is capable of performing “spoofing.” Spoofing means sending acknowledgments to the partner of the data session saying that the session is open and the data that was sent has been received by the other side. Therefore, the session can be put on hold from the user's point of view, however, the remote site thinks that the session is still open. When the user wants to resume the session the user informs session management server 20 and session management server resumes the data flow to the user.

Examples of the source of the data session include the Internet 50, a WAP gateway 70 or an MMS server 30. Internet 50 can also be any network such as a private network, fixed line network, cables, DSL, etc.

When a data session is put on hold by mobile handset 10, the data session continues to run between session management server 20 and the data source. This enables mobile handset 10 to be more responsive to a user's requests and eliminates the problem of a handset becoming unusable during a data session. If the data source continues to transmit data, session management server 20 receives and buffers the data. The length of time that the data is buffered varies depending of the server and system design. In addition, if the handset does not resume the session within a predetermined time, the data can be saved for later use.

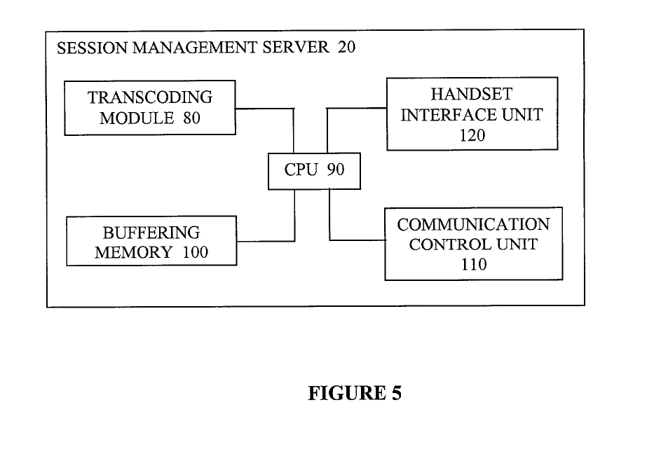

FIG. 5 is a block diagram of an embodiment of session management server 20. Session management server 20 includes a communication control unit 110, buffering memory 100, handset interface unit 120, CPU 90 and transcoding module 80.

Communications control unit 110 communicates with content servers/sites and keeps data sessions alive by providing all of the necessary communication control commands.

Buffering memory 100 buffers data that is received between the content servers/sites and handset 10.

Handset interface unit 120 communicates with the handset by identifying handset commands such as STOP SESSION, RESUME SESSION, SWAP, etc. These commands are executed by communication control unit 110.

CPU 90 controls the operation of session management server 20.

Transcoding module 80 converts pictures and/or graphics to existing screen sizes and performs other functions such as ZOOM.

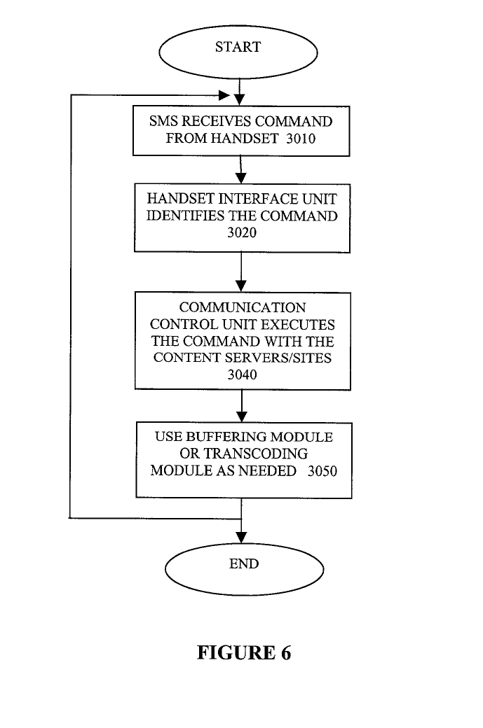

FIG. 6 is a flow chart illustrating the basic operation of session management server 20. First, session management server 20 receives a command from handset 10 (3010). Handset interface unit 120 then identifies the command (3020). Communication control unit 110 executes the command with the content servers/sites (3040). Depending on the particular command, buffering memory 100 and/or transcoding module 80 are used.

If only one data session is running and no data manipulation features are being used, session management server 20 acts as a transparent device for data flow. However, the user can activate session management server 20 at any time.

An example of the data manipulation feature, e.g., ZOOM, will be described below. The user initiates a data session by requesting a picture or video. Mobile handset 10 typically has a display with a fixed size and resolution. However, session management server 20 receives a picture that has a higher resolution such that it would fit on a PC screen, but not on a typical handset screen. Because of the buffering capability of session management server 20, the user can ask for the data to be zoomed. Session management server 20 keeps the session with the source open, enlarges (or shrinks) a section of the picture and sends the zoomed picture to the user.

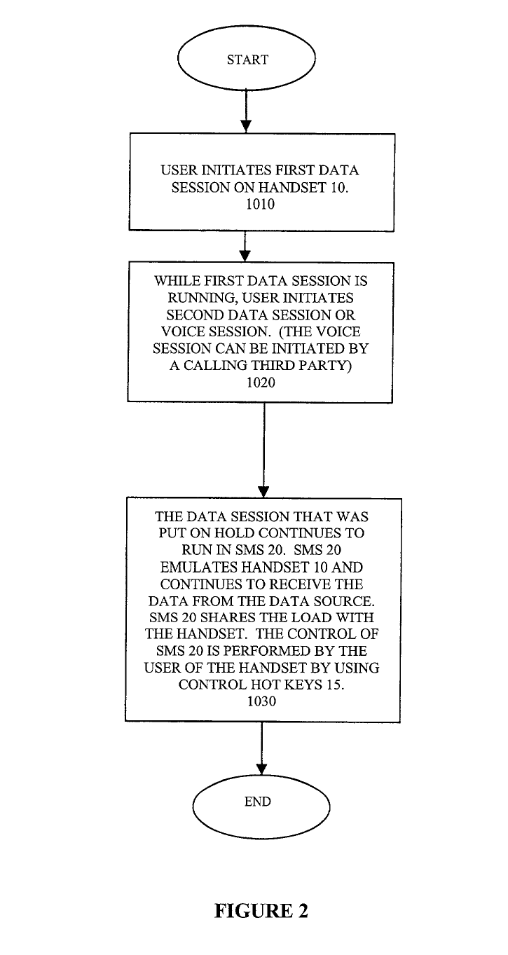

FIG. 2 generally describes the inventive method. First, the user initiate a data session on handset 10 (1010). While the first data session is running, the user initiates a second data session or voice session (the voice session can be initiated by a calling third party). When this happens, the first data session is put on hold (1020). Then, the data session that was put on hold continues to run in session management server 20 (1030). Session management server 20 acts as handset 10 and continues to receive the data from the data source. Session management server 20 thus minimizes the load on handset 10. For example, handset 10 does not need to control all open sessions and session management server 20 stores any received data until handset 10 needs it. The user controls session management server 20 by using handset 10's control hot keys 15.

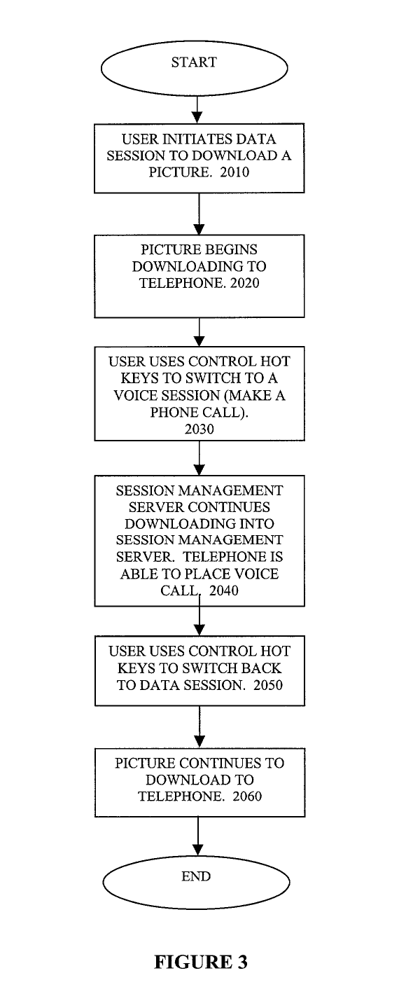

FIG. 3 is an illustrative example of the inventive method. The specific example involves a cellular telephone user that starts to download a picture, but then wants to place a voice call before the picture download is complete. The user initiates a data session and starts to download a picture (2010). The picture begins to download to the cellular telephone (2020). The user then uses at least one control hot key 15 to switch to a voice session to make a telephone call (2030). At this point, session management server 20 continues the data session with the content providers/sites and the picture continues to download in session management server 20, instead of in the cellular telephone. The cellular telephone is now ready to place a voice call (2040). After the user finishes the voice call, at least one control hot key 15 is used to switch back to the data session (2050). The picture that has continued to download into session management server 20 then continues to download into the cellular telephone from session management server 20, picking up at the point at which the data session was switched to a voice session (2060).

The same method would be performed if there were two data sessions instead of one data session and one voice session.

An example an enhanced data manipulation feature, e.g., fast forwarding to an MP3 string that has not completely downloaded, is described below. This feature is possible because the bit rate between session management server 20 and the data source can be much faster than the bit rate between session management server 20 and the user device, such as a handset. Therefore, a user could select fast forward and session management server 20 can run faster with the source by skipping over certain content packets in order to provide a fast forward effect.

First, the user initiates a data session and starts to download an MP3 file. The MP3 file begins to download to the cellular telephone. The user then activates the fast forward function by using control hot keys 15. Session management server 20 then skips over earlier portions of the MP3 file that it has received, to later portions of the MP3 file that it has received, and forwards the later packets to the cellular telephone, creating a fast forward effect. In addition to fast forwarding MP3 files, the present invention can be used to fast forward other large text or video files.

The present invention can also be used to fast forward to specific points of audio, video and text files. For example, session management server 20 could rely on technical pauses in the file such as the end of a song, video track, text paragraph or voicemail message. As an example, if a user is currently downloading or playing an MP3 file, the user could select the NEXT SONG command and the session management server 20 would skip to the next song in the MP3 file.

What is claimed is:

1. A system for managing a session comprising:
a first device that is able to receive data from a data source; and
a session management server connected to the first device and the data source that controls the flow of data from the data source to the first device;
wherein the first device is used to control the session management server.

2. The session management system of claim 1, wherein the first device further comprises a control device that is used to control the session management server.

3. The session management system of claim 1, wherein the first device is a cellular telephone.

4. The session management system of claim 1, wherein the first device is a personal data assistant.

5. The session management system of claim 1, wherein the first device is a personal computer.

6. The session management system of claim 1, wherein the data source is the Internet.

7. The session management system of claim 1, wherein the data source is a WAP gateway.

8. The session management system of claim 2, wherein the control device comprises at least one key.

9. The session management system of claim 8, wherein the at least one key is dedicated to control only the session management server.

10. The session management system of claim 8, wherein the at least one key performs other functions in addition to controlling the session management server.

11. The session management system of claim 1, further comprising a multimedia messaging server connected between the session management server and the data source.

12. The session management system of claim 1, further comprising a cellular radio base station that connects the first device to the session management server.

13. The session management system of claim 1, further comprising a Bluetooth station that connects the first device to the session management server.

14. The session management system of claim 1, further comprising a modem that connects the first device to the session management server.

15. The session management system of claim 1, wherein the session management server performs a data manipulation function.

16. The session management system of claim 15, wherein the data manipulation function is at least one of zoom and fast forward.

17. The session management system of claim 15, wherein the data manipulation function allows a user to fast forward to specific points in at least one of an audio, video and text file.

18. The session management system of claim 15, wherein the session management server continues to receive data from the data source while the data manipulation function is being performed.

19. A system for managing a plurality of sessions comprising:
a first device that is able to receive data from a data source; and
a session management server connected to the first device and the data source that controls the flow of data from the data source to the first device;
wherein the first device is used to control the session management server.

20. The session management system of claim 19 wherein said first device further comprises a control device that is used to control the session management server.

21. The session management system of claim 19, wherein the session management server continues to receive data for the first device from the data source when the first device is involved in another session.

22. The session management system of claim 20, wherein the control device allows the first device to switch from one session to another session.

23. The session management system of claim 19, wherein one of the sessions is a data session and another session is a voice session.

24. The session management system of claim 19, wherein the session management server buffers data for the first device from the data source when the first device is involved in another session.

25. The session management system of claim 19, wherein the session management server controls the flow of data for the first device from the data source when the first device is involved in another session.

26. A method for managing a plurality of sessions comprising:
initiating a first session in a first device connected to a data source;
initiating a second session in the first device while the first data session is still running;
stopping the first session in the first device; and
continuing the first session in a session management server.

27. The session management method of claim 26, further comprising resuming the first session in the first device at the point at which the first session was interrupted.

28. The session management method of claim 26, wherein the first session and the second session are both data sessions.

29. The session management method of claim 26, wherein the first session is a data session and the second session is a voice sessions.

30. The session management method of claim 26, wherein the first device is a cellular telephone.

31. The session management method of claim 26, wherein the first device is a personal data assistant.

32. The session management method of claim 26, wherein the first device is a personal computer.

33. The session management method of claim 26, wherein the first and second sessions are initiated using at least one key.

34. The session management method of claim 26, wherein the first session comprises downloading a data file.

35. The session management method of claim 26, wherein the data source is the Internet.

36. The session management method of claim 26, wherein the data source is a WAP gateway.

37. A method for managing a session comprising:
initiating a session in a first device to download data from a data source; and
manipulating the data while the session is still running and prior to all of the data being downloaded to the first device

38. The session management method of claim 37, wherein said data manipulation comprises zooming in on a portion of the data.

39. The session management method of claim 37, wherein said data manipulation comprises forwarding to a later portion of a stream of data.

40. A method for managing a session comprising:
initiating a session in a first device connected to a data source;
stopping the first session in the first device; and
continuing the first session in a session management server.

41. The session management method of claim 40, further comprising resuming the stopped first session in the first device at the point at which the session was interrupted.
